(19) United States
(12) Patent Application Publication
(10) Pub. No.: US 2007/0294758 A1
(43) Pub. Date: Dec. 20, 2007

(54) Method for Registering a Mobile Communication Terminal in a Local Area Network

(75) Inventors: Stefan Berg, Wesel (DE); Wolfgang Groting, Oberhausen (DE); Kalyan Koora, Augsburg (DE)

Correspondence Address: LERNER GREENBERG STEMER LLP, P O BOX 2480, HOLLYWOOD, FL, 33022-2480, US

(73) Assignee: Siemens Aktiengesesllschaft

(21) Appl. No.: 11/666,248

(22) PCT Filed: Sep. 6, 2005
(86) PCT No.: PCT/EP05/54387

§ 371 Date: May 18, 2007

(30) Foreign Application Priority Data
Oct. 25, 2004 (DE) 10204051840.8

(51) Int. Cl. H04L 29/06

(52) U.S. Cl. 726/14

(57) ABSTRACT

The invention relates to a method for registering a mobile communication terminal in a local area network. A server transmits a first identity data request message that contains an identity request message and a network data element via an access point to the mobile communication terminal in one step. The network data element contains information for the mobile communication terminal that additional data is transmitted to the mobile communication terminal via the access point in the framework of additional identity data request messages. And, at least one second identity data request message, which contains an identity request message that can be ignored as well as at least some of the second data to be transmitted from the server via the access point, is transmitted to the mobile communication terminal.

The invention relates to a method for registering a mobile communication terminal in a local area network, having the steps:

Transmitting a start message from the mobile communication terminal to an access point in the local area network,

b) transmitting an identity request message from the access point to the mobile communication terminal

c) transmitting an identity response message from the mobile communication terminal to the access point and forwarding the identity response message to a server,

e) implementing an authentication method between the server and the mobile communication terminal

d) transmitting an authentication success message from the server to the access point and forwarding the authentication success message from the access point to the mobile communication terminal.

Such a method for registering a communication terminal in a local area network (WLAN) is standardized for instance within the scope of the “EAP” protocol (EAP—“Extensible Authentication Protocol”), see IETF RFC 3748. This protocol defines the message structure as well as an exchange of data, which primarily serve to authenticate the mobile communication terminal in the network. In this way, a type of authentication between a client, for instance a mobile communication terminal and an authentication server is negotiated. Generic token cards, MD5-CHAP (Encryption of user names and passwords) and Transport Level Security (Smartcards or other certificates) are supported as authentication methods for instance.

The EAP protocol was extended in the standardization body IETF responsible therefor such that aside from the abovementioned data serving authentication purposes, additional data, namely information relating to available network providers, can be transmitted. In this context, reference is made to the professional article by Farid Adrangi entitled “Mediating Network Discovery and Selection”, IETF, Internet Draft, draft-adrangi-eap-network-discovery-and-Selection-02.txt, February 2004. The transmitted data volume is in this way directly dependent on a number of the supported network providers and can thus become very large.

A transmission of data, which differs from the data for authentication purposes, according to the illustrated prior art is thus restricted such that details relating to network providers are sent from a server within the network to a requesting mobile communication terminal. According to Adrangi, this takes place in the form of a combined identity-request/network information message, which is sent from the server to the mobile communication terminal by way of the access point.

Starting from here, the object underlying the invention is to design the registration method described at the beginning for a mobile communication terminal in a local network such that starting from the server large data volumes can be transmitted to the mobile communication terminal with no more than minor changes to the EAP protocol.

This object is achieved with the method of the type mentioned at the beginning such that in step e) a first identity information request message, which contains an identity request message and network information, is sent from the server to the mobile communication terminal by way of the access point, with the network information containing the information to the mobile communication terminal such that within the scope of further identity information request messages, further data is transmitted to the mobile communication terminal by way of the access point and at least one second identity information request message, which contains an identity request message which can be ignored and at least one part of the further data from the server by way of the access point, is sent to the mobile communication terminal.

The basic idea behind the invention is thus to repeatedly send the provided identity information request message, whereby only the first identity request message, which receives the mobile communication terminal, is to be further processed by said terminal within the scope of an authentication. The further identity information request messages likewise contain identity request messages, which can however be ignored on the part of the mobile communication terminal. The purpose of the identity information request messages is, in the case of the first, to inform the mobile communication terminal such that further data is made available by the server and in the case of the further identity information request messages, to transmit the advised data, by maintaining the format provided for the identity information request message.

On the basis of this procedure, it is possible that no additional EAP service primitives have to be provided. In this respect, conformity is given with the IETF concept from Adrangi.

As the identity information request messages, both the first and also the further, are sent from the server to the mobile communication terminal by way of the access point prior to the actual authentication, the method is highly advantageous in order to send network information to the mobile communication terminal operating as a client. The number of identity information request messages, which are transmitted from the server to the mobile communication terminal, is unrestricted on the part of the EAP protocol, so that large data volumes can be transported in this direction.

It is advantageous if the identity information request messages contain a number of identity information request messages, said identity information request message still arriving as data from the server to the mobile communication terminal by way of the access point. In this way, an item of information is provided to the latter as to how many identity information request messages are to be expected, until the data volume to be transmitted is completely received.

Identity information request messages can advantageously contain, as data, details relating to a data volume still to be transmitted from the server to the mobile communication terminal by way of the access point, so that details relating to bits/bytes, which are to be received, are present on the part of the mobile communication terminal. In this respect, a completeness test relating to received data volumes is possible.

The identity information request messages can also contain details relating to a number of already sent identity information request messages and/or identity request messages as data so that it is possible to include for the mobile communication terminal when the advised number of messages has been received and thus the data volume to be transmitted is complete.

Previous embodiments apply to the first identity information request message in the same way as for the further messages.

In a similar manner to the identity request message, the identity request message already provided within the EAP protocol can also serve as a basis for a transportation of data from the mobile communication terminal back to the server. To this end, the identity response message is combined with data for instance, which contain details relating to a number of already sent identity request messages from the server to the mobile communication terminal by way of the access point. Conclusions can be drawn from this detail on the server side to determine whether the identity information request messages already sent to the mobile communication terminal have been previously completely received.

It is also possible for the mobile communication terminal, on receipt of the identity information request messages, to send identity information response messages to the server by way of the access point, said messages containing confirmation elements in each instance about the receipt of the data from the previous identity information request message. In this way, a confirmation is sent back for each identity information request message reaching the mobile communication terminal from the server, said confirmation confirming a successful receipt. The identity information response message can also contain details relating to a data volume which has already been received. In this way, the basis for a complete transmission of the network information from the server to the mobile communication terminal reverts back to the transmitted data quantity, i.e. not to the identity information request messages received by the mobile communication terminal. A tracing of the data volume involves a lower error rate than a restriction to the number of received identity information request messages. To ensure a particularly simple confirmation of a receipt of network information from the server, the network information and/or the associated data which has just been received can be sent back to the server as a confirmation message. This data is then part of the identity information response message.

The method is preferably based on the EAP protocol, in particular according to the IETF RFC 3748. This publication can be downloaded from the internet at no cost for instance.

The invention is explained in more detail below with reference to an exemplary embodiment with reference to the drawings, in which;

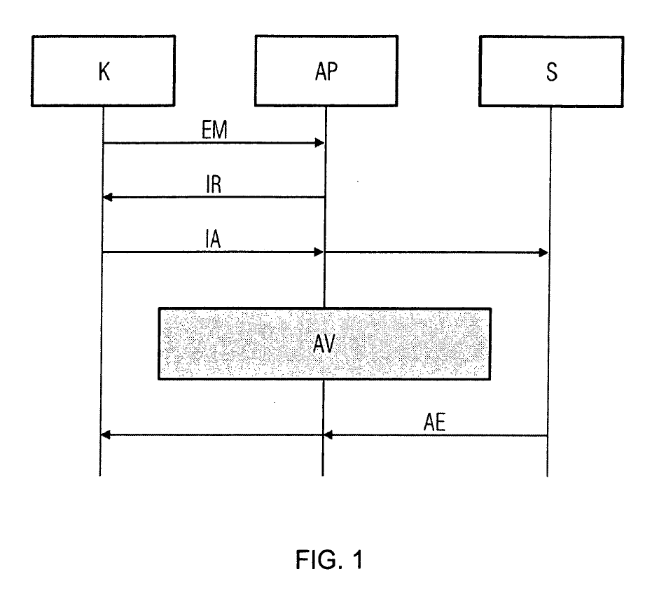

FIG. 1 shows a schematic representation of a registration method according to the EAP protocol for a mobile communication terminal in a local area network

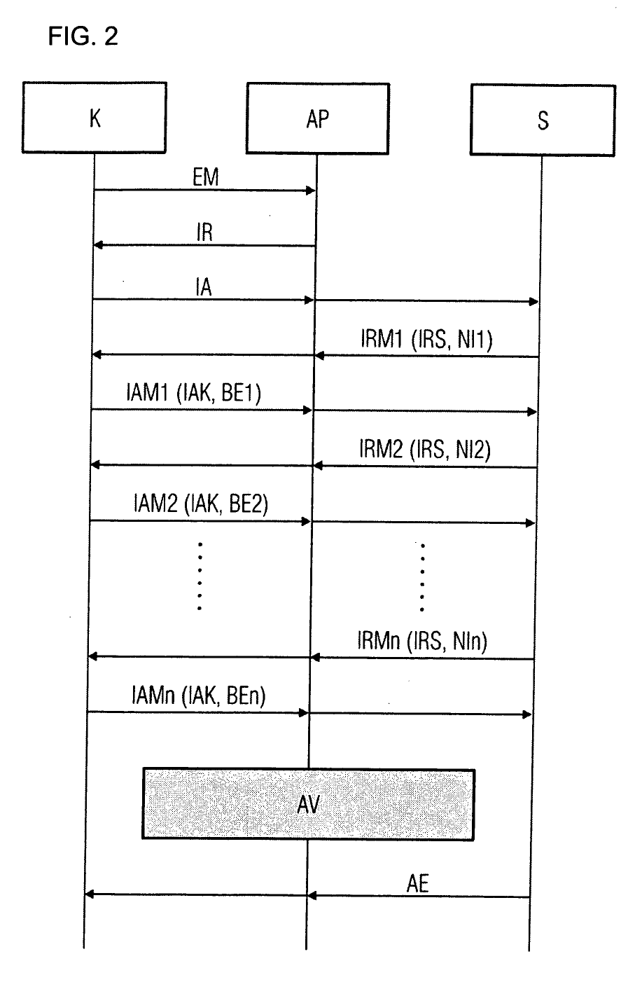

FIG. 2 shows a method for registering a mobile communication terminal in a local network with transmission of network information starting from the network to the mobile communication terminal.

FIG. 1 shows a schematic representation of messages, which proceed according to the EAP protocol within the scope of a registration method for a mobile communication terminal K as a client in a sever S, in particular authentication server of a local area network (WLAN) having wireless access.

In a first step, the mobile communication terminal K sends an EAPOL message EM in order to start a registration process, said message being received from an access point AP of the local area network. Consequently, the access point AP sends an identity request message IR back to the mobile communication terminal K, which in turn thereupon sends an identity response message IA to the access point AP, which forwards the identity response message IA to the server S.

In connection with this, an authentication method AV takes place between the mobile communication terminal K and the server S by switching the access point AP, said method being described in more detail below with reference to FIG. 2. With successful implementation, the registration process is concluded by means of an authentication success message AE which reaches the mobile communication terminal K from the server S by way of the access point AP. After this method has been successfully concluded, the services of the local area network can be utilized on the part of the mobile communication terminal K.

The start of the authentication method AV is particularly relevant to the invention from now on, said authentication method being carried out between the server S and the communication terminal K, in order to allow the latter access to the local area network.

The authentication method AV is, as can be seen in FIG. 2, initiated by an identity request message IRS of the server S, which reaches the mobile communication terminal K starting from the access point AP. The identity request message IRS is embedded in an identity information request message IRM1, IRM2, . . . , IRMn, which, in addition to the identity request message IRS, contains a network information element N1I. According to the suggestion by Adrangi, as already described above, such network information elements would be able to be exclusively used for the purpose of providing information relating to available network providers. According to the invention, the identity information request message IRM1, in particular its network information element N1I, serves in particular to inform the mobile communication terminal K inter alia that within the scope of further identity information request messages IRM2 . . . , IRMn, . . . further data is to be transmitted from the server S to the mobile communication terminal K.

Each identity information request message IRM1, IRM2, . . . , IRMn contains network information elements NI1, NI2, NI3 in each instance, which in turn contain details relating to a number of identity information request messages IRM2, IRM2, . . . , IRMn which are still arriving or the number of bits/bytes still to be transmitted and the number of identity information request messages IRM1, IRM2, . . . , IRMn which have already been sent, with all this information serving to determine on the part of the mobile communication terminal K whether a previous data transmission has existed from the server S to the mobile communication terminal device K. Preparations for further data transfers can be made.

An identity information response message IAM1, IAM2, . . . , IAMn belongs to each identity information request message IRM1, IRM2, . . . , IRMn, said identity information response message transmitting the mobile communication terminal K in each instance as a response to a preceding identity information request message IRM1, IRM2, . . . , IRMn. The identity information response messages IRM1, IRM2, . . . , IRMn, . . . , all contain an identity response message IAK which can be ignored on the part of the server as well as a confirmation element BE1, BE2, . . . , BEn, which specifies in each instance how many bytes/bits have already arrived with the mobile communication terminal K, this serving as a confirmation/status information for the server S. Alternatively or in addition, the confirmation elements BE1, BE2, . . . , BEn can contain the data received with the previously received network information element NI1, NI2, NI3, which can be further processed to verify the correctness of the transmitted data on the server side.

On the part of the mobile communication terminal K, it is possible to check when the message IAK required for accepting the authentication method AV is sent to the server S. To this end, the payload data NI1, NI2, . . . , NIn received by the server S can be used for the evaluation, because it emerges herefrom when a data transfer from the server S to the communication terminal K is concluded. In this respect, the message IAK must not be contained in all identity information response messages IAM1, IAM2, . . . , IAMn. It is in general possible to ensure that the authentication method AV is not started before the data transfer of payload data NI1, NI2, . . . , NIn from the server S to the communication device K is concluded.

1-8. (canceled)

9. A method for registering a mobile communication terminal in a local area network, the method which comprises the following steps:
a) transmitting a start-message from the mobile communication terminal to an access point in the local area network;
b) transmitting an identity request message from the access point to the mobile communication terminal;
c) transmitting an identity response message from the mobile communication terminal to the access point and forwarding the identity response message to a server;
e) implementing an authentication process between the server and the mobile communication terminal, by:
transmitting a first identity information request message, which contains an identity request message and a network information element, from the server to the mobile communication terminal by way of the access point, with the network information element containing information to the mobile communication terminal that, within the scope of further identity information request messages, further data is transmitted to the mobile communication terminal by way of the access point; and
transmitting to the mobile communication terminal at least one further identity information request message, which contains an identity request message that can be ignored and at least one part of the second data to the server by way of the access point; and
f) transmitting an authentication success message from the server to the access point and forwarding the authentication success message from the access point to the mobile communication terminal.

10. The method according to claim 9, wherein the identity information request messages contain, as data, a number of identity information request messages still arriving from the server to the mobile communication terminal by way of the access point.

11. The method according to claim 9, wherein the identity information request messages contain, as data, details relating to a data volume still to be transmitted from the server to the mobile communication terminal by way of the access point.

12. The method according to claim 9, wherein the identity information request messages contain, as data, details relating to a number of identity information request messages already sent from the server to the mobile communication terminal by way of the access point.

13. The method according to claim 9, which comprises, on receipt of the identity information request messages, transmitting with the mobile communication terminal identity information response messages to the server by way of the access point, that contain confirmation elements relating to the receipt of the data from a preceding identity information request message.

14. The method according to claim 13, wherein the identity information response message contains a data volume that has already been received as the data.

15. The method according to claim 14, wherein the identity information response message contains, as data, data received by the server on receipt of the preceding identity information request message.

16. The method according to claim 13, wherein the identity information response message contains, as data, data received by the server on receipt of the preceding identity information request message.

17. The method according to claim 9, which comprises processing on the basis of EAP protocol (IETF REC 3748).
